(19) United States
(12) Patent Application Publication
(10) Pub. No.: US 2019/0383249 A1
(43) Pub. Date: Dec. 19, 2019

(54) INTAKE DUCT FOR INTERNAL COMBUSTION ENGINE

(71) Applicant: TOYOTA BOSHOKU KABUSHIKI KAISHA, Aichi-ken (JP)

(72) Inventors: Tomoyo OHNO, Nagoya-shi (JP); Ryusuke KIMURA, Ichinomiya-shi (JP)

(73) Assignee: TOYOTA BOSHOKU KABUSHIKI KAISHA, Aichi-ken (JP)

(21) Appl. No.: 16/438,058

(22) Filed: Jun. 11, 2019

(30) Foreign Application Priority Data
Jun. 14, 2018 (JP) 2018-113488
Jun. 14, 2018 (JP) 2018-113489

(51) Int. Cl. F02M 35/10

(52) U.S. Cl. CPC F02M 35/10052; F02M 35/10262; F02M 35/10124

(57) ABSTRACT

An intake duct for an internal combustion engine includes a tubular side wall. The side wall includes a first split body and a second split body that are separate from each other in a peripheral direction of the side wall. The first split body includes a rib that divides an inside of the side wall into passages and extends in an extending direction of the side wall. A distal end of the rib in a protruding direction of the rib is spaced apart from an inner surface of the second split body. A portion of the second split body opposed to the distal end is provided with a breathable part that allows air to flow between the inside and an outside of the side wall.

### BACKGROUND

### 1. Field

The following description relates to an intake duct for an internal combustion engine.

### 2. Description of Related Art

An intake passage for an onboard internal combustion engine includes an intake duct having a tubular side wall. Further, in some cases, in order to prevent the side wall of an intake duct from deforming/closing due to intake negative pressure or to reduce pressure loss, the inner wall of the intake duct is provided with a rib that divides the inside of the side wall into passages (refer to, for example, Japanese Laid-Open Patent Publication No. 2004-196180). Typically, the side wall of the intake duct is configured by two tubular split bodies. A first split body, which is one of the split bodies, includes a support. The support protrudes inward from the side wall of the first split body and supports the inner surface of a second split body, which is the other one of the split bodies.

In accordance with a typical intake duct such as the one described in the document cited above, vibration of the vehicle, variation in the negative intake pressure, and the like vibrate the side wall. This causes the distal surface of the support (herein referred to as rib) to interfere with the inner surface of the second split body. As a result, noise and wear can occur. To limit such detrimental effects, the distal surface of the rib may be spaced apart from the inner surface of the second split body.

However, in the intake duct, in addition to the vicinity of the inner surface of the side wall and the vicinity of the side surface of the rib, turbulent boundary layers occur between the distal surface of the rib and the inner surface of the second split body. Thus, when the cross-sectional flow area of the mainstream of intake air is limited by such turbulent boundary layers, the pressure loss and airflow resistance of intake air will increase.

### SUMMARY

It is an objective of the following description to provide an intake duct for an internal combustion engine that reduces the airflow resistance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An intake duct according to the following description includes a tubular side wall. The side wall includes a first split body and a second split body that are separate from each other in a peripheral direction of the side wall. The first split body includes a rib that divides an inside of the side wall into passages and extends in an extending direction of the side wall. A distal end of the rib in a protruding direction of the rib is spaced apart from an inner surface of the second split body. A portion of the second split body opposed to the distal end is provided with a breathable part that allows air to flow between the inside and an outside of the side wall.

Other features and aspects will be apparent from the following detailed description, the drawings, and the claims.

### BRIEF DESCRIPTION OF THE DRAWINGS

FIG. 1 is a perspective view showing an intake duct for an internal combustion engine according to a first embodiment.

FIG. 2 is a cross-sectional view taken along line 2-2 in FIG. 1.

FIG. 3 is a cross-sectional view showing a modification of the intake duct according to the first embodiment, corresponding to FIG. 2.

FIG. 4 is a cross-sectional view showing another modification of the intake duct according to the first embodiment, corresponding to FIG. 2.

FIG. 5 is a cross-sectional view showing a further modification of the intake duct according to the first embodiment, corresponding to FIG. 2.

FIG. 6 is a perspective view showing an intake duct for an internal combustion engine according to a second embodiment.

FIG. 7 is a cross-sectional view taken along line 7-7 in FIG. 6.

FIG. 8 is a cross-sectional view showing a modification of the intake duct according to the second embodiment, corresponding to FIG. 7.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described arc thorough and complete, and convey the full scope of the disclosure to one of ordinary skill in the art.

### First Embodiment

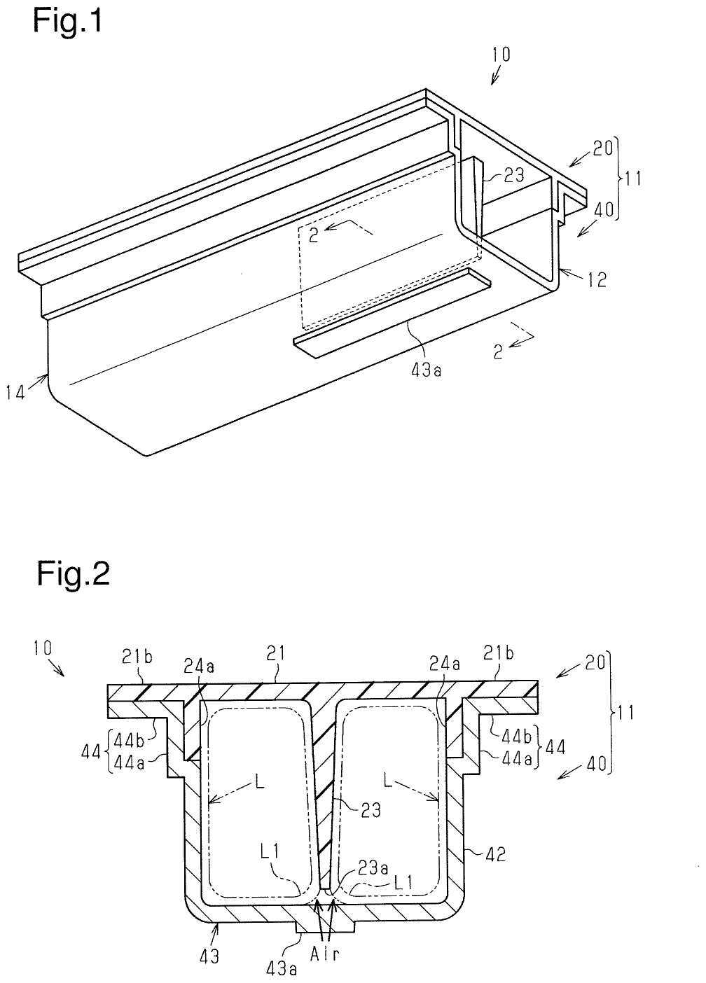

An intake duct for an internal combustion engine according to a first embodiment (hereinafter referred to as intake duct 10) will now be described with reference to FIGS. 1 and 2. In the following description, the upstream side and the downstream side in the flow direction of intake air in the intake duct 10 are simply referred to as an upstream side and a downstream side, respectively.

As shown in FIG. 1, the intake duct 10 includes an entirely box-shaped tubular side wall 11. The upstream end of the intake duct 10 is provided with an inlet 12 into which intake air is drawn. The downstream end of the intake duct 10 is provided with a connection port 14 connected to, for example, an air cleaner.

The side wall 11 includes a first split body 20 and a second split body 40. The first split body 20 and the second split body 40 are separate from each other in a peripheral direction of the side wall 11.

Referring to FIG. 2, the first split body 20 is made of a plastic molded body and includes a flat top wall 21. The top wall 21 includes opposite ends 21b in a width direction of the top wall 21 (sideward direction in FIG. 2). Portions of the top wall 21 located inward from the opposite ends 21b are provided with two joints 24a protruding to the second split body 40. Each joint 24a extends entirely in the extending direction of the side wall 11.

The second split body 40 is made of a fibrous molded body. The second split body 40 includes a bottom wall 43 and two side walls 42. The bottom wall 43 is opposed to the top wall 21 of the first split body 20. The side walls 42 are curved from the opposite ends of the bottom wall 43 in the width direction to extend to the joints 24a of the first split body 20. The inner surface of each side wall 42 of the second split body 40 is evenly continuous with the inner surface of the corresponding joint 24a of the first split body 20.

The end of each side wall 42 is provided with a flange 44 protruding outward. Each flange 44 includes a first joint 44a and a second joint 44b. Each first joint 44a extends to the top wall 21 of the first split body 20 and is joined to the outer surface of the corresponding joint 24a. Each second joint 44b is bent from the first joint 44a to extend outward and joined to the corresponding end 21b of the top wall 21. The flanges 44 are arranged entirely in the extending direction of the side wall 11. The joints 24a and the opposite ends 21b of the first split body 20 are respectively joined to the first joints 44a and the second joints 44b of the second split body 40 using, for example, adhesive.

A plate-shaped rib 23 that divides the inside of the side wall 11 into two passages protrudes from the top wall 21 of the first split body 20. As shown in FIG. 1, the rib 23 extends from a position located downstream of the inlet 12 in the extending direction of the side wall 11 without reaching the end of the side wall 11.

Referring to FIG. 2, the rib 23 is made of a plastic molded body and integrated with the first split body 20. The rib 23 includes a distal end 23a spaced apart from the bottom wall 43.

The portion of the bottom wall 43 of the second split body 40 opposed to the distal end 23a of the rib 23 is provided with a breathable part 43a having breathability. The opposite ends of the breathable part 43a in the width direction are respectively located outward from the opposite side surfaces of the rib 23. Further, the breathable part 43a corresponds to the entire rib 23 in the extending direction of the rib 23 (refer to FIG. 1).

The fibrous molded body configuring the second split body 40 will now be described.

The fibrous molded body is made of nonwoven fabric of a PET fiber and nonwoven fabric of core-sheath composite fibers each including, for example, a core (not shown) made of polyethylene terephthalate (PET) and a sheath (not shown) made of denatured PET having a lower melting point than the PET fiber. The denatured PET, which serves as the sheath of the composite fibers, is used as a binder for binding the fibers to each other.

The mixture percentage of denatured PET may be 30 to 70%. For example, in the first embodiment, the mixture percentage of denatured PET is 50%.

Such a composite fiber may also include polypropylene (PP) having a lower melting point than PET.

The mass per unit area of the fibrous molded body may be 500 to 1500 g/m². For example, in the first embodiment, the mass per unit area of the fibrous molded body is 800 g/m².

The second split body 40 is formed by thermally compressing (thermally pressing) the above-described nonwoven sheet having a thickness of, for example, 30 to 100 mm.

More specifically, in the second split body 40, the side walls 42, the portions of the bottom wall 43 other than the breathable part 43a, and the flanges 44 are configured by non-breathable high-compression portions. The breathable part 43a is configured by a breathable low-compression portion that has undergone thermo-compression molding at a lower compressibility than the high-compression portions.

The high-compression portions have a breathability (JIS L 1096 A-Method (Frazier Method)) of approximately 0 cm³/cm²·s. Further, the high-compression portions may have a thickness of 0.5 to 1.5 mm. For example, in the first embodiment, the high-compression portions have a thickness of 0.7 mm.

The low-compression portion has a breathability of approximately 3 cm³/cm²·s. Further, the low-compression portion may have a thickness of 0.8 to 3.0 mm. For example, in the first embodiment, the low-compression portion has a thickness of 1.0 mm.

The operation of the first embodiment will now be described.

As shown in FIG. 2, in the intake duct 10, turbulent boundary layers L occur around the inner surface of the side wall 11 and around the side surface of the rib 23. Further, turbulent boundary layers LI occur between the distal end 23a of the rib 23 and the bottom wall 43 of the second split body 40. In the turbulent boundary layers L and L1, the kinetic energy of air is zero.

In the first embodiment, the portion of the second split body 40 opposed to the distal end 23a is provided with the breathable part 43a, which allows air to flow between the inside and outside of the side wall 11 of the intake duct 10. Thus, intake negative pressure generated in the intake duct 10 as the internal combustion engine is running causes external air to be drawn into the intake duct 10 through the breathable part 43a. When external air is drawn in such a manner, kinetic energy is supplied to the turbulent boundary layers L1, which occur around the distal end 23a of the rib 23. This reduces the thickness of the turbulent boundary layers L1 and thus prevents the cross-sectional flow area of the main stream of intake air from being limited by the turbulent boundary layers L1. Thus, the airflow resistance is limited.

The advantages of the first embodiment will now be described.

(1) The intake duct 10 includes the tubular side wall 11. The side wall 11 includes the first split body 20 and the second split body 40, which are separate from each other in the peripheral direction of the side wall 11. The first split body 20 includes the rib 23, which divides the inside of the side wall 11 into passages and extends in the extending direction of the side wall 11. The distal end 23a of the rib 23 in the protruding direction of the rib 23 is spaced apart from the inner surface of the second split body 40. The portion of the second split body 40 opposed to the distal end 23a includes the breathable part 43a, which allows air to flow between the inside and outside of the side wall 11 of the intake duct 10.

Such a structure operates as described above and thus reduces the airflow resistance.

(2) The second split body 40 is made of a fibrous molded body.

In such a structure, as compared to a structure in which the body of the second split body 40 is integrated with a breathable part 43a that is separate from the body, the number of components used for the second split body 40 is reduced.

(3) The second split body 40 includes the low-compression portion, which is breathable, and the high-compression portions, which are non-breathable and formed at a higher compressibility than the low-compression portion. The breathable part 43a is configured by the low-compression portion.

In such a structure, the breathability of the breathable part 43a is easily controlled in accordance with the degree of compression of the fibrous molded body.

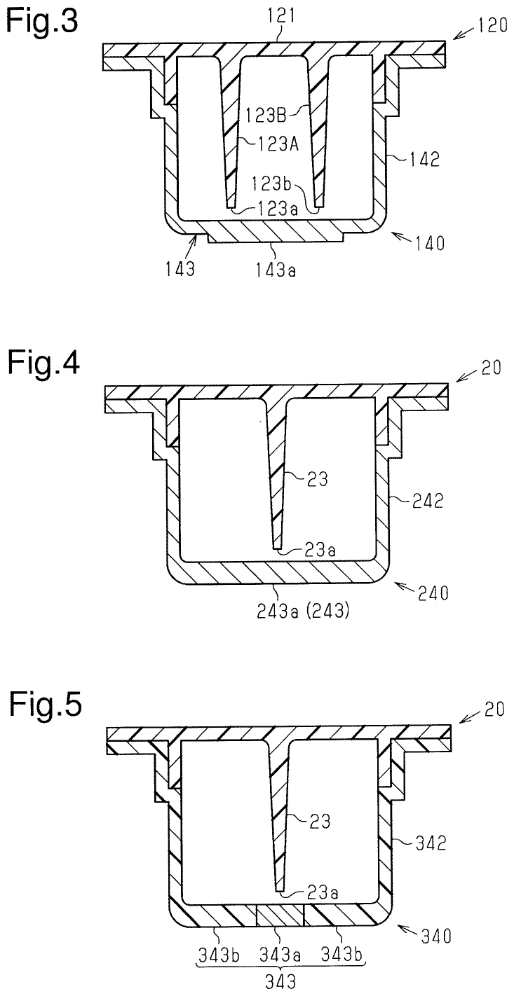

The first embodiment may be embodied as follows. The first embodiment and the following modifications may be implemented in combination with each other as long as technical contradiction does not occur. In the following modifications, like or same reference numerals are given to those components that are the same as the corresponding components of the first embodiment. Such components will not be described in detail. Reference numbers in which number 100 is added to the reference numbers of the components of the first embodiment are given to the components of the modification shown in FIG. 3, reference numbers in which number 200 is added to the reference numbers of the components of the first embodiment are given to the components of the modification shown in FIG. 4, and reference numbers in which number 300 is added to the reference numbers of the components of the first embodiment are given to the components of the modification shown in FIG. 5. Such components will not be described.

Ribs 23 may be arranged such that the ribs 23 are spaced apart from one another in the extending direction of the side wall 11. In this case, a breathable part 43a should simply be arranged in accordance with the distal end 23a of each rib 23.

As shown in FIG. 3, a top wall 121 of a first split body 120 may be provided with two ribs 123A and 123B such that the ribs 123A and 123B are spaced apart from each other in the width direction. In this case, a common breathable part 143a may be arranged in a range including portions of a bottom wall 143 of a second split body 140 opposed to distal ends 123a and 123b of the ribs 123A and 123B. Alternatively, two breathable parts may be arranged in correspondence with the distal ends 123a and 123b of the ribs 123A and 123B.

As shown in FIG. 4, a bottom wall 243 of a second split body 240 may be entirely configured by a breathable part 243a.

Referring to FIG. 5, the first split body 20 and a second split body 340 may be both formed by a plastic molded body. In this case, a portion of a bottom wall 343 of the second split body 340 opposed to the distal end 23a should simply be provided with a separate breathable part 343a made of a fibrous molded body. In this case, the breathable part 343a may be joined to plastic parts 343b of the bottom wall 343 that are adjacent to the breathable part 343a using, for example, adhesive. Alternatively, the breathable part 343a may be inserted to form the bottom wall 343 and side walls 342 of the second split body 340.

### Second Embodiment

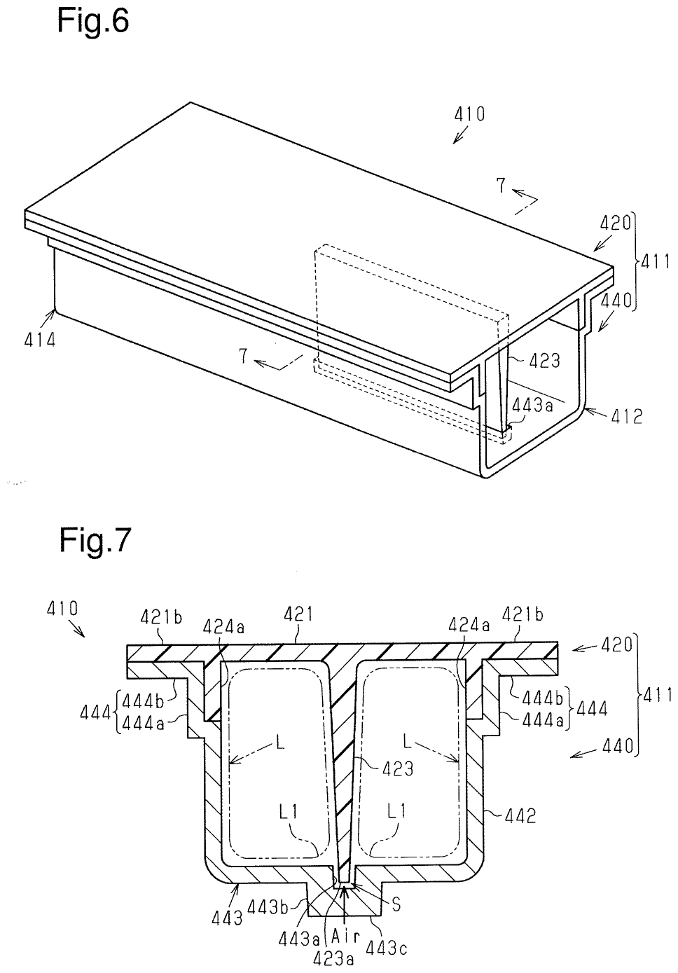

An intake duct for an internal combustion engine according to a second embodiment (hereinafter referred to as intake duct 410) will now be described with reference to FIGS. 6 and 7. In the following description, the upstream side and the downstream side in the flow direction of intake air in the intake duct 410 are simply referred to as an upstream side and a downstream side, respectively.

As shown in FIG. 6, the intake duct 410 includes an entirely box-shaped tubular side wall 411. The upstream end of the intake duct 410 is provided with an inlet 412 into which intake air is drawn. The downstream end of the intake duct 410 is provided with a connection port 414 connected to, for example, an air cleaner.

The side wall 411 includes a first split body 420 and a second split body 440. The first split body 420 and the second split body 440 are separate from each other in a peripheral direction of the side wall 411.

Referring to FIG. 7, the first split body 420 is made of a plastic molded body and includes a flat top wall 421. The top wall 421 includes opposite ends 421b in a width direction of the top wall 421 (sideward direction in FIG. 7). Portions of the top wall 421 located inward from the opposite ends 421b are provided with two joints 424a protruding to the second split body 440. Each joint 424a extends entirely in the extending direction of the side wall 411.

The second split body 440 is made of a fibrous molded body. The second split body 440 includes a bottom wall 443 and two side walls 442. The bottom wall 443 is opposed to the top wall 421 of the first split body 420. The side walls 442 are curved from the opposite ends of the bottom wall 443 in the width direction to extend to the joints 424a of the first split body 420. The inner surface of each side wall 442 of the second split body 440 is evenly continuous with the inner surface of the corresponding joint 424a of the first split body 420.

The end of each side wall 442 is provided with a flange 444 protruding outward. Each flange 444 includes a first joint 444a and a second joint 444b. Each first joint 444a extends to the top wall 421 of the first split body 420 and is joined to the outer surface of the corresponding joint 424a. Each second joint 444b is bent from the first joint 444a to extend outward and joined to the corresponding end 421b of the top wall 421. The flanges 444 are arranged entirely in the extending direction of the side wall 411. The joints 424a and the opposite ends 421b of the first split body 420 are respectively joined to the first joints 444a and the second joints 444b of the second split body 440 using, for example, adhesive.

A plate-shaped rib 423 that divides the inside of the side wall 411 into two passages protrudes from the top wall 421 of the first split body 420. As shown in FIG. 6, the rib 423 extends from a position located downstream of the inlet 412 in the extending direction of the side wall 411 without reaching the end of the side wall 411.

Referring to FIG. 7, the rib 423 is made of a non-breathable plastic molded body and integrated with the first split body 420.

The portion of the bottom wall 443 of the second split body 440 opposed to the distal end 423a of the rib 423 is provided with an accommodation recess 443a that accommodates the distal end 423a with a clearance. The accommodation recess 443a corresponds to the entire rib 423 in the extending direction of the rib 423 (refer to FIG. 6).

The portion of the bottom wall 443 that configures the accommodation recess 443a is thicker than other portions of the bottom wall 443 and includes two sides 443b and a bottom 443c. The two sides 443b configure the inner side surfaces of the accommodation recess 443a. The bottom 443c configures the bottom surface of the accommodation recess 443a. A gap S is provided between the distal end 423a of the rib 423 and the accommodation recess 443a (more specifically, the inner side surfaces and the bottom surface of the accommodation recess 443a). That is, the distal end 423a of the rib 423 is spaced apart from the inner surface of the second split body 440.

The fibrous molded body configuring the second split body 440 will now be described.

The fibrous molded body is made of nonwoven fabric of a PET fiber and nonwoven fabric of core-sheath composite fibers each including, for example, a core (not shown) made of polyethylene terephthalate (PET) and a sheath (not shown) made of denatured PET having a lower melting point than the PET fiber. The denatured PET, which serves as the sheath of the composite fibers, is used as a binder for binding the fibers to each other.

The mixture percentage of denatured PET may be 30 to 70%. For example, in the second embodiment, the mixture percentage of denatured PET is 50%.

Such a composite fiber may also include polypropylene (PP) having a lower melting point than PET.

The mass per unit area of the fibrous molded body may be 500 to 1500 g/m². For example, in the second embodiment, the mass per unit area of the fibrous molded body is 800 g/m².

The second split body 440 is formed by thermally compressing (thermally pressing) the above-described nonwoven sheet having a thickness of, for example, 30 to 100 mm.

More specifically, in the second split body 440, the side walls 442, the portions of the bottom wall 443 other than the sides 443b and the bottom 443c, and the flanges 444 are configured by non-breathable high-compression portions. Further, the sides 443b and the bottom 443c of the bottom wall 443, which configure the accommodation recess 443a, are configured by breathable low-compression portions that have undergone thermo-compression molding at a lower compressibility than the high-compression portions.

The high-compression portions have a breathability L 1096 A-Method (Frazier Method)) of approximately 0 cm³/cm²·s. Further, the high-compression portions may have a thickness of 0.5 to 1.5 mm. For example, in the second embodiment, the high-compression portions have a thickness of 0.7 mm.

The low-compression portions have a breathability of approximately 3 cm³/cm²·s. Further, the low-compression portions may have a thickness of 0.8 to 3.0 mm. For example, in the second embodiment, the low-compression portion has a thickness of 1.0 mm.

The operation of the second embodiment will now be described.

As shown in FIG. 7, in the intake duct 410, turbulent boundary layers L occur around the inner surface of the side wall 411 and around the side surface of the rib 423. Further, turbulent boundary layers LI occur around the distal end 423a of the rib 423. In the turbulent boundary layers L and L1, the kinetic energy of air is zero.

In the second embodiment, the distal end 423a of the rib 423 of the first split body 420 is accommodated in the accommodation recess 443a of the second split body 440 with a clearance, that is, with the gap S. Further, the second split body 440 is made of a fibrous molded body that has undergone compression molding, and the portion of the second split body 440 configuring the accommodation recess 443a has breathability that allows air to flow between the inside and outside of the side wall 411. That is, the portion of the second split body 440 configuring the accommodation recess 443a is opposed to the distal end 423a of the rib 423 and configures the breathable part that allows air to flow between the inside and outside of the side wall 411. Thus, intake negative pressure generated in the intake duct as the internal combustion engine is running causes external air to be drawn into the accommodation recess 443a through the portion configuring the accommodation recess 443a (breathable part). When external air is drawn in such a manner, kinetic energy is supplied to the turbulent boundary layers LI, which occur around the distal end 423a of the rib 423. This reduces the thickness of the turbulent boundary layers L1 and thus prevents the cross-sectional flow area of the main stream of intake air from being limited.

In addition, the distal end 423a of the rib 423 of the first split body 420 is accommodated in the accommodation recess 443a of the second split body 440. Thus, even if eddies are generated in the gap S between the distal end 423a of the rib 423 and the accommodation recess 443a, such eddy currents are generated in the accommodation recess 443a. This prevents the cross-sectional flow area of the main stream of intake air from being limited by the eddy currents. Accordingly, the airflow resistance is limited.

The advantages of the second embodiment will now be described.

(4) The intake duct 410 includes the tubular side wall 411. The side wall 411 includes the first split body 420 and the second split body 440, which are separate from each other in the peripheral direction of the side wall 411. The first split body 420 includes the rib 423, which divides the inside of the side wall 411 into passages and extends in the extending direction of the side wall 411. The second split body 440 is made of a fibrous molded body that has undergone compression molding. The portion of the inner surface of the second split body 440 opposed to the distal end 423a of the rib 423 in the protruding direction of the rib 423 is provided with the accommodation recess 443a, which accommodates the distal end 423a with a clearance. The sides 443b and the bottom 443c of the second split body 440, which configure the accommodation recess 443a, have breathability that allows air to flow between the inside and outside of the side wall 411. That is, the portion of the second split body 440 configuring the accommodation recess 443a is opposed to the distal end 423a of the rib 423 and configures the breathable part that allows air to flow between the inside and outside of the side wall 411.

Such a structure operates as described above and thus reduces the airflow resistance.

(5) The second split body 440 includes the low-compression portions, which are breathable, and the high-compression portions, which are non-breathable and formed at a higher compressibility than the low-compression portions. The accommodation recess 443a is arranged at the low-compression portion.

In such a structure, the second split body 440 includes the breathable low-compression portions and the non-breathable high-compression portions. Thus, whereas portions that need to be highly rigid are configured by the high-compression portions, the accommodation recess 443a and portions that do not need to be highly rigid are configured by the low-compression portions. This ensures the rigidity of the second split body 440.

The second embodiment may be embodied as follows. The second embodiment and the following modifications may be implemented in combination with each other as long as technical contradiction does not occur.

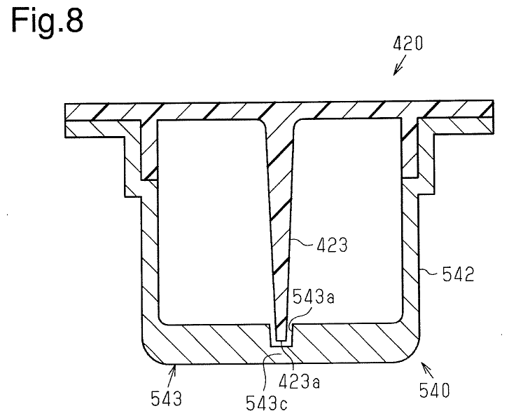

As shown in FIG. 8, a second split body 540 includes a bottom wall 543. In this case, whereas only a thin portion 543c of the bottom wall 543 that configures the bottom surface of an accommodation recess 543a may be configured by a high-compression portion, portions of the bottom wall 543 other than the thin portion 543 may be entirely configured by low-compression portions. In the components of FIG. 8, like or same reference numerals are given to those components that are the same as the corresponding components of the second embodiment, and reference numbers in which number 100 is added to the reference numbers of the components of the second embodiment are given to the components of the modification shown in FIG. 8. Such components will not be described in detail.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples.

Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An intake duct for an internal combustion engine, the intake duct comprising:
a tubular side wall, wherein the side wall includes a first split body and a second split body that are separate from each other in a peripheral direction of the side wall, the first split body includes a rib that divides an inside of the side wall into passages and extends in an extending direction of the side wall, a distal end of the rib in a protruding direction of the rib is spaced apart from an inner surface of the second split body, and a portion of the second split body opposed to the distal end is provided with a breathable part that allows air to flow between the inside and an outside of the side wall.

2. The intake duct according to claim 1, wherein the second split body is made of a fibrous molded body.

3. The intake duct according to claim 2, wherein
the second split body includes a breathable low-compression portion and a non-breathable high-compression portion formed at a higher compressibility than the low-compression portion, and the breathable part is configured by the low-compression portion.

4. The intake duct according to claim 1, wherein
the second split body is made of a fibrous molded body that has undergone compression molding,
a portion of the inner surface of the second split body opposed to the distal end of the rib is provided with an accommodation recess that accommodates the distal end with a clearance, and
a portion of the second split body configuring the accommodation recess has breathability that allows air to flow between the inside and the outside of the side wall and configures the breathable part.

5. The intake duct according to claim 4, wherein
the second split body includes a breathable low-compression portion and a non-breathable high-compression portion formed at a higher compressibility than the low-compression portion, and
the accommodation recess is arranged at the low-compression portion.
